(19) United States
(12) Patent Application Publication
(10) Pub. No.: US 2002/0182290 A1
(43) Pub. Date: Dec. 5, 2002

(54) Method for processing fish material

(75) Inventor: Per Munk Nielsen, Hillerod (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 10/133,911

(22) Filed: Apr. 26, 2002

Related U.S. Application Data
(60) Provisional application No. 60/291,820, filed on May 17, 2001.

(30) Foreign Application Priority Data
May 1, 2001 (DK) PA 2001 00678

(51) Int. Cl. A23L 1/31

(52) U.S. Cl. 426/56

(57) ABSTRACT

The present invention relates to a method for processing fish material including fish bones, into a product with good nutritional properties. The method comprises heat treating fish bones essentially free from fish meat. The fish product is useful as an ingredient in food, feed and other products.

### CROSS-REFERENCE TO RELATED APPLICATIONS

This application claims under 35 U.S.C. 119, priority of Danish application no. PA 2001 00678, filed May 1, 2001, and the benefit of provisional application no. 60/291,820 filed May 17, 2001, the contents of which are fully incorporated herein by reference.

### TECHNICAL FIELD

The present invention relates to a method for processing fish material comprising fish bones, in particular for the manufacturing of feed products.

### BACKGROUND OF THE INVENTION

Production of fish in fish farming is of increasing importance, and development of fish based feed products is becoming more and more important. The marine resources for usage in fish based feed are limited and there is a need for better methods of utilisations of fish raw materials for this purpose. Use of proteolytic treatment of fish bodies has been disclosed for removing fish meat from fish bones, cf. for example U.S. Pat. No. 4,976,973, U.S. Pat. No. 4,861,602, U.S. Pat. No. 518,741 and JP Laid-Open 109,210/1991.

Fish raw materials are widely used in production of feed products for fish as well as for other animals like poultry, pigs, cattle and fur animals. The fish material is often used in combination with other ingredients as for instance soy. The fish raw material is processed into fish meal by a heating, pressing, separation, and drying process, after which the product is in dried form known as fish meal. The fish meal is characterised by having a dry matter composition different from the raw material as the oil content has been reduced considerably. The other components, is kept as part of the composition. The nutritional value is important which has lead to the development of fish meal produced at lower temperatures. These are known in the market as LT fish meal (Low Temperature fish meal). LT meal is having a better nutritional value due to better digestibility of the proteins. Also the appearance of fish meals is important, a white or light colour is desired.

The present inventor has discovered that when fish bones essentially free from fish meat is heat-treated in accordance with the invention this result in an improved product inter alia by an increased digestibility. Additionally, a less dark colour is formed resulting in a more desirable appearance. Accordingly, the invention among other factors provide an improved digestibility of fish based feed products, which is a factor influencing both growth rate and pollution.

### DETAILED DESCRIPTION OF THE INVENTION

The invention relates to a method for processing fish material comprising the steps of (i) providing fish bones essentially free from fish meat, e.g. by proteolytic treatment; and (ii) in the presence of water heating these fish bones at a temperature corresponding to at least the temperature of boiling water at atmospheric pressure.

The expression “fish bones essentially free from fish meat” means in a preferred embodiment that the fish bones contain 100% (w/w) or less of fish meat attached to the bones, e.g. at most 75%, at most 60%, at most 50%, at most 40%, at most 30%, at most 25%, at most 20%, or at most 10% fish meat attached to the fish bones. The content of fish meat on in the fish bone material may be measured by weighing the content of fish bone material in the starting material compared to the weight of a washed and screened sample of fish bone material. It is preferred that the fish bones are essentially free from fish meat since heating of fish meat protein will reduce the digestibility and induce the formation of an undesirable dark color.

The fish meat may be removed from the fish bones by any method including mechanical and/or enzymatic methods. In a preferred embodiment, the fish bone is made essentially free from fish meat by treatment with one or more proteolytic enzymes combined with a mechanical separation step. The process may comprise treating fish bodies or parts thereof with a protease to give a slurry; the fish bones almost free from fish meat can be obtained by sieving the slurry, which slurry free from the fish bones may be divided into solid and liquid matters e.g. by using a continuous decanter to separate the oil from the water phase and the sediment phase.

Accordingly, the process of the invention may comprise contacting a fish material with a protease under conditions effective to remove the fish meat from the fish bones; removing the liquid containing the fish meat from the solid fish bones; heat treatment the fish bones in accordance with the invention and optionally followed by drying and grinding the fish bones to obtain a fish meal.

The term “fish material” includes any fish material comprising fish bones. The fish material may be intact whole fish bodies or parts thereof. Thus, the process of the invention may comprise a step of dividing whole fish bodies into pieces. The fish material may also be waste from filleting, e.g. of salmon. The fish material may be from any fish, e.g. selected from the group consisting of white fish, red fish or pelagic fish such as sprat, cod, haddock, tuna, seaeel, salmon, herring, sardine, mackerel, saury, round herring, Alaska pollack, flatfish, anchovy and pilchard or any combinations thereof. It is understood that the fish material comprises bones.

It is preferred that the fish material is substantially raw before, during and after the separation of fish meat from the fish bones and before the heating treatment in step (ii). The expression “substantially raw” means fish material that has not been processed by heating the fish material to temperatures above denaturation temperature of the proteins, i.e. in one embodiment above approx. 35° C.

A preferred method of the invention for producing a fish based product suitable for feed production comprises the step of (i) providing fish bones substantially free from fish meat by a process comprising contacting a fish material with one or more proteases under conditions effective to remove fish meat from the fish bones of said fish material; and a separation step wherein the fish bones is separated from the hydrolysed fish meat; and (ii) heating the fish bones of step (i) in the presence of water. The process of the invention may further comprise inactivation of said protease.

The inventor has discovered that by process of the invention, in particular the step of heating in the presence of water fish bones, which are essentially free from fish meat, is obtained a fish based product having improved properties including improved digestibility and/or increased water binding capacity and/or improved appearance. Accordingly, in a preferred embodiment, this heating step of the fish bones is conducted so as to provide an increase in water binding capacity and/or digestibility compared a similar process without such heat-treatment. In another preferred embodiment, this heating step of the fish bones is conducted so as to provide an increase in water binding capacity of more than 10%, preferably at least 15%, at least 20% or at least 25% (w/w) compared to not-heat-treated bones, i.e. bones not treated with such process step, cf. Example 1. In further embodiments, this heating step of the fish bones is conducted so as to provide an increase in the digestibility measured as an increase in soluble protein after treatment in an in vitro feed assay is at least 5%, preferably at least 10% (w/w) compared to not-heat-treated bones.

The degree of digestibility may be measured by the following in vitro feed assay as an increase in solubilized crude protein and digested crude protein. The assay is treatment in a “Gastric phase” at pH 3 with HCl, and pepsin for 6 hours at 15° C. followed by a “Intestinal phase”, which is a treatment at 15° C. for 18 hours with pancreatin. The sample is centrifuged and the nitrogen is determined in the supernatant (soluble crude protein) and amounts of peptides smaller than 1500 daltons is defined as digested crude protein.

In further embodiments, the heating step of the fish bones in the presence of water is conducted at a temperature of at least the temperature of boiling water at atmospheric pressure, preferably in the range of 100-150° C., e.g. in the range of 115-150° C. or 120-150° C. The preferred duration of the heat treatment depends on the temperature involved. The heating step may, e.g., be conducted at the temperature of boiling water at atmospheric pressure for at least 1 hour, such as in the range of 2 to 8 hours or a similar heat load, e.g. at least 125° C. for at least 10 minutes, such as e.g. about 30 minutes, e.g. about 140° C. for ½-60 minutes. e.g. about 150° C. for 10 seconds to 30 minutes.

The inventor has found that heating in the presence of water fish bones essentially free from fish meat gives a significant different product than by the heating provided by only drying the bones. The expression “heating in the presence of water” is mean as opposed to a drying process. Water in the presence context includes any liquid. On the other hand it is preferred that the bones during the heating process are not immersed in water or any other liquid but rather the water presence is provided by the water content of the bone material. If the bones are cooked traditionally in plenty of water this will lead to a loss of the fish bones material into the water which is not desirable. Thus, the heating step (ii) in the process of the invention is preferably conducted without drying, i.e. without substantive loss of water and without further addition of water prior to heating. In a preferred embodiment, the heating step is performed at a water content in the range of 50-80% w/w.

The heating may be performed by any heating equipment. Preferably, the heating is performed in an essentially closed container, inter alia to avoid substantive evaporation of the water present. The heating may e.g. be performed by pressure cooking. e.g. for about 125° C. and about 30 minutes, such as in the range of 120° C. to 150° C. at corresponding holding times of about 40 minutes to 10 seconds, respectively.

The method of the invention may further comprise using the fish bones after said heating step corresponding to step (ii) as an ingredient in a feed formulation.

The method of the invention may further comprise drying the fish bones after said heating step corresponding to step (ii). The drying may be performed by e.g. vacuum or flash drying, e.g. obtain a water content below 15% (w/w).

Additionally, the method of the invention may further comprise milling said fish bones, in particular to provide fish bone meal. In case the heat-treated fish bones are dried the milling may be performed before or after the drying treatment.

The process of the invention may also comprise a step of collecting fish oil from the fish material.

The removed fish meat, in particular, in case a protease has been used the hydrolyzed fish meat, may be combined with the heat-treated fish bone product resulting from the process of the invention, said fish meat may be more or less processed before the combination with the fish bone product of the invention. The hydrolyzed fish meat may also be introduced into raw fish meat, e.g. by injection, such as filet of e.g. salmons.

### PROTEASES

The term protease as used herein is an enzyme that hydrolyses peptide bonds (has protease activity). Proteases are also called e.g. peptidases, proteinases, peptide hydrolases, or proteolytic enzymes.

The proteases for use in the process of the invention may be any protease suitable for removing fish meat from the fish bones. The protease may e.g. be of the endo-type that acts 10 internally in polypeptide chains (endopeptidases). Endopeptidases show activity on N- and C-terminally blocked peptide substrates that are relevant for the specificity of the protease in question. In other embodiments it may be an exopeptidase. It may be one or more proteases, i.e. with a combination of different proteases.

Examples of the protease to be used in the present invention include proteinases such as acrosin, urokinase, uropepsin, elastase, enteropeptidase, cathepsin, kallikrein, kininase 2, chymotrypsin, chymopapain, collagenase, streptokinase, subtilisin, thermolysin, trypsin, thrombin, papain, pancreatopeptidase and rennin; peptidases such as aminopeptidases, for example, arginine aminopeptidase, oxytocinase and leucine aminopeptidase; angiotensinase, angiotensin converting enzyme, insulinase, carboxypeptidase, for example, arginine carboxypeptidase, kininase 1 and thyroid peptidase, dipeptidases, for example, carnosinase and prolinase and pronases; as well as other proteases, denatured products thereof and compositions thereof. These proteases may be classified into exopeptidases acting from the end of a polypeptide chain and endopeptidases acting inside thereof depending on the mode of their actions, and the latter is preferable.

Proteases are classified on the basis of their catalytic mechanism into the following groupings: serine proteases (S), cysteine proteases (C), aspartic proteases (A), metalloproteases (M), and unknown, or as yet unclassified, proteases (U), see Handbook of Proteolytic Enzymes, A. J. Barrett, N. D. Rawlings, J. F. Woessner (eds), Academic Press (1998), in particular the general introduction part. The protein may belong to any of these classes provided.

There are no limitations on the origin of the protease for use according to the invention. Thus, the term protease includes not only natural or wild-type proteases, but also any mutants, variants, fragments etc. thereof exhibiting protease activity, as well as synthetic proteases, such as shuffled proteases, and consensus proteases. Such genetically engineered proteases can be prepared as is generally known in the art, e.g. by Site-directed Mutagenesis, by PCR (using a PCR fragment containing the desired mutation as one of the primers in the PCR reactions), or by Random Mutagenesis. The preparation of consensus proteins is described in e.g. EP 897985.

The protease for use in the process of the invention may be of a microbial protease, the term microbial indicating that the protease is derived from, or originates from, a microorganism, or is an analogue, a fragment, a variant, a mutant, or a synthetic protease derived from a microorganism. It may be produced or expressed in the original wild-type microbial strain, in another microbial strain, or in a plant; i.e. the term covers the expression of wild-type, naturally occurring proteases, as well as expression in any host of recombinant, genetically engineered or synthetic proteases. The term microorganism as used herein includes Archaea, bacteria, fungi, vira etc. Examples of microorganisms are bacteria, such as bacteria of the genus Bacillus. Further examples of microorganisms are fungi, such as yeast or filamentous fungi, e.g. Paecilomyces, e.g. Paecilomyces lilacinus, Aspergillus, e.g. Aspergillus sp., Acremonium, e.g. Acremonium chrysogenum, Acremonium kiliense, or Fusarium, e.g. Fusarium oxysporum; or mutants or variants thereof exhibiting protease activity. In other embodiments the protease is a plant protease.

The protease treatment is conducted at any condition found suitable for the protease in question and to provide a desired separation of fish meat from the fish bones. The protease treatment may e.g. be conducted at 30-80° C., preferably for about 45 minutes at about 55° C.

### THE PRODUCT OF THE INVENTION AND ITS APPLICATION

As described above the method of the invention may also be used for producing a fish meal and a fish oil. The properties of the fish bone product obtained by the method of the invention makes it particularly useful as a feed ingredient. Accordingly, the method of the invention may further comprise the step of combining the heat-treated fish bones in a animal feed formula.

In relation to animal feed products, the term animal includes all animals, including human beings. In a preferred embodiment the term animal does not include human beings. Examples of animals are non-ruminants, and ruminants, such as cows, sheep and horses. In a particular embodiment, the animal is a non-ruminant animal. Non-ruminant animals include mono-gastric animals, e.g. pigs or swine (including, but not limited to, piglets, growing pigs, and sows); poultry such as turkeys and chicken (including but not limited to broiler chicks, layers); young calves; and fish (including but not limited to salmon). The term feed or feed composition means any compound, preparation, mixture, or composition suitable for, or intended for intake by an animal. The product of the process of the invention can be (a) added directly to the feed, or (b) it can be used in the production of one or more intermediate compositions such as feed additives or premixes that is subsequently added to the feed.

The invention relates to the incorporation the fish bone product so produced into a feed, pet food or food product or into a non-food product, such as e.g. a cosmetic product or a fertilizer. Due to the improvement of the water binding capacity, the invention also relates to a water binding composition comprising a fish bone product of the invention.

The invention further relates to any products obtained by the process of the invention, i.e. a fish bone product obtainable by any of the methods of the invention as disclosed herein, including an animal feed, a pet food or a food product comprising a fish bone product of the invention.

Other embodiments relates to a method for improving the nutritional value of animal feed comprising fish material, said method comprising addition of a fish bone product of the invention.

The invention also relates to the use of a fish bone product of the invention, e.g. in the manufacturing of animal feed, a pet food or a food product and the use of such products, e.g. as a feed additive, including the use of a fish bone product of the invention in the preparation of a composition for use in animal feed. Also within the scope of the invention is the use as fertilizer of a fish bone product obtained by the method of the invention.

The present invention is further illustrated in the following example which is not to be in any way limiting to the scope of protection.

### EXAMPLE 1

### METHOD

150 kg fish raw material consisting of backbones with remains of fish meat from production of salmon filets was added water in ratio 1 part of backbones to 0.8 water (on weight basis). Temperature was adjusted to 55° C. and Bacillus endoprotease preparation (Protamex 1.5 MG™) was added at a dosage of 1 g per kg fish raw material (a dosage of 1 g corresponds to an activity of 1.5 AU). Hydrolysis for 45 minutes at 55° C. was followed by heating to 95° C. for 15 minutes to inactivate the enzymes. The material was sieved to collect the bones which were now free from fish meat. From 150 kg backbone was achieved 18.75 kg clean bones. The remaining 131.25 kg is removed as a liquid containing soluble and partly soluble protein together with the oil.

Three batches each of 300 g bone material free from fish meat from the hydrolysis mentioned above were heated in a closed container without adding water (according to the conditions mentioned in Table 1). After the heating the bone samples were dried in an oven at 105° C. for 16 hours. In Table 1 is also shown the water binding capacity of the dried bone. The water binding capacity was measured by weighing off 50 g dried bone, which was pulverized in a blender and gradually adding as much water as the bone powder can absorb. The amount of water absorbed (in % w/w) of dry bone is expressed as the water binding.

TABLE 1

| | Temperature | Holding | Water | Color |
|---|---|---|---|---|
| | (° C.) | time | binding | of dried bones |
| 1. Control sample | No heating | — | 76% | Brown |
| 2. | 100 | 4 hours | 130% | Light yellowish |
| 3. | 125 | 30 minutes | 121% | Light yellowish |

### RESULTS

It is clear that by heating the bones in the presence of water (samples 2 and 3) prior to drying the bones achieve improved properties with respect to both water binding and colour compared to the control sample. It was surprising to see the results of the control, which had received some heat treatment during the drying, did not develop as good properties as the other two samples. This shows that heating the bones in a drying process develops much different from heating in the presence of water.

1. A method for production of a fish based product comprising:
(a) providing fish bones essentially free from fish meat by treating said fish bones with one or more proteolytic enzymes under conditions effective to remove the fish meat from the fish bones; and
(b) heat treating the fish bones in the presence of water at a temperature corresponding to at least the temperature of boiling water at atmospheric pressure.

2. The method of claim 1, wherein the fish bones are essentially free from fish meat in that they contain 50% (w/w) or less of fish meat attached to the bones.

3. The method of claim 1, wherein the heating step of the fish bones is conducted to provide an increase in water binding capacity and/or digestibility compared to a similar process without such heat-treatment.

4. The method of claim 2, wherein the heating step of the fish bones is conducted to provide an increase in water binding capacity and/or digestibility compared to a similar process without such heat-treatment.

5. The method of claim 3, wherein the water binding capacity increases more than 10% (w/w).

6. The method of claim 5, wherein the water binding capacity increases more than 25% (w/w).

7. The method of claim 3, wherein the digestibility increase measured as an increase in soluble protein after treatment in an in vitro feed assay is at least 5% (w/w) compared to not-heat-treated bones.

8. The method of claim 7, wherein the digestibility increase is at least 10% (w/w) compared to not-heat-treated bones.

9. The method of any of the preceding claims, wherein the heating step of the fish bones in the presence of water is conducted at a temperature of at least the temperature of boiling water, preferably in the range of 100-150° C.

10. The method of claim 9, wherein said heating step is conducted at the temperature of boiling water at atmospheric pressure for at least 1 hour, such as in the range of 2 to 8 hours or a similar heat load.

11. The method of any of the preceding claims, wherein the bones is from a fish selected from the group consisting of white fish, red fish or pelagic fish such as sprat, cod, haddock, tuna, seaeel, salmon, herring, sardine, mackerel, saury, round herring, Alaska pollack, flatfish, anchovy and pilchard or any combinations thereof.

12. The method of any of the preceding claims, wherein the fish material is substantially raw before the separation of fish meat from the fish bones.

13. The method of any of the preceding claims, further comprising inactivation of said proteolytic enzyme or enzymes.

14. The method of any of the preceding claims, further comprising collecting fish oil from the fish material.

15. The method of any of the preceding claims, further comprising a drying treatment of the fish bones after said heating step.

16. The method of claim 15, further comprising milling said fish bones.

17. The method of any of the preceding claims, further comprising the step of combining said heat treated fish bones in a feed formula.

18. The method of any of the preceding claims, further comprising incorporating the fish bone product so produced into a feed, pet food or food product.

19. The method of any of the preceding claims, further comprising incorporating the fish bone product so produced into a non-food product, such as e.g. a cosmetic product or a fertilizer.

20. A fish bone product obtainable by any of the preceding claims.

21. An animal feed, a pet food or a food product comprising the fish bone product of claim 20.

22. A method for improving the digestibility and/or nutritional value of animal feed or pet food comprising fish material, said method comprising addition of a fish bone product obtained by the method of any of claims 1-19.

23. Use of a fish bone product obtained by the method of any of claims 1-19 in animal feed, a pet food or a food product.

24. Use of a fish bone product obtained by the method of any of claims 1-19 as a feed additive.

25. Use of a fish bone product obtained by the method of any of claims 1-19 as a fertilizer.

26. A water binding composition comprising a fish bone product obtained by the method of any of claims 1-19.
